(19) United States
(12) Patent Application Publication
(10) Pub. No.: US 2019/0037216 A1
(43) Pub. Date: Jan. 31, 2019

(54) VIDEO SIGNAL ENCODING/DECODING METHOD AND APPARATUS FOR SAME

(71) Applicant: Electronics and Telecommunications Research Institute, Daejeon (KR)

(72) Inventor: Seung Hyun CHO, Daejeon (KR)

(73) Assignee: Electronics and Telecommunications Research Institute, Daejeon (KR)

(21) Appl. No.: 16/071,715

(22) PCT Filed: Feb. 14, 2017
(86) PCT No.: PCT/KR2017/001617

§ 371 Date: Jul. 20, 2018

(30) Foreign Application Priority Data
Mar. 2, 2016 (KR) 10-2016-0025187
Mar. 4, 2016 (KR) 10-2016-0026257

(51) Int. Cl. H04N 19/129; H04N 19/176; H04N 19/91; H04N 19/96; H04N 19/159; H04N 19/46

(52) U.S. Cl. CPC H04N 19/129; H04N 19/176; H04N 19/46; H04N 19/96; H04N 19/159; H04N 19/91

(57) ABSTRACT

The present invention relates to a method and apparatus for designating a processing order of multiple units when encoding a video signal, and for decoding the video signal according to the designated processing order. The method for encoding a video signal includes: partitioning an encoding target block into a plurality of sub-blocks; determining a processing order of the sub-blocks included in the encoding target block; and entropy decoding information of the processing order of the sub-blocks.

### TECHNICAL FIELD

The present invention relates to a method and apparatus for designating a processing order of multiple units when encoding a video signal, and for decoding the video signal according to the designated processing order.

### BACKGROUND ART

As the demand for high-definition video service having high resolution, high frame rates, high bit-depth, etc. increases, there is a need for a codec for efficiently encoding and decoding a substantial amount of video data.

In a conventional video codec, coding tree units are encoded/decoded based on raster scanning order, and coding units in a coding tree unit are encoded/decoded in series based on zigzag scanning order. Prediction units in a coding unit are encoded/decoded in series based on an index being assigned to the prediction unit depending on partition pattern of the coding unit.

As described above, in a conventional video codec, the processing order of units is fixed. Like this, in a case of limiting the processing order of units, the location of a previously encoded/decoded unit is limited when encoding/decoding a unit. That is, the locations of previously decoded units that may be referred to when encoding/decoding a current unit are limited, and thus encoding/decoding efficiency decreases.

### DISCLOSURE

### Technical Problem

The present invention is intended to propose a method and apparatus for encoding/decoding a video signal to designate a processing order of units.

Specifically, the present invention is intended to propose a method and apparatus for determining a processing order of units in a video encoding process, and for successively processing the units in a video decoding process according to the processing order determined in the encoding process.

It is to be understood that technical problems to be solved by the present disclosure are not limited to the aforementioned technical problems and other technical problems that are not mentioned will be apparent from the following description to a person with an ordinary skill in the art to which the present disclosure pertains.

### Technical Solution

According to one aspect of the present invention, there is provided a method for encoding a video signal, the method including: partitioning an encoding target block into a plurality of sub-blocks; determining a processing order of the sub-blocks included in the encoding target block; and entropy decoding information of the processing order of the sub-blocks.

Here, the processing order may be selected among a plurality of processing order combinations that are generated by using the sub-blocks, with reference to results of decoding the encoding target block by using each of the processing order combinations.

Here, the processing order may be determined based on at least one of sizes of the sub-blocks, locations of the sub-blocks, or prediction modes for the sub-blocks.

Here, the processing order of a sub-block may be determined to precede when the size of the sub-block is larger than other sub-blocks.

Here, the processing order of a sub-block encoded in inter prediction may be determined to precede the processing order of a sub-block encoded in intra prediction.

Here, the encoding target block may be a coding tree unit, each of the sub-blocks may be a coding unit included in the coding tree unit, and the coding tree unit may be partitioned in a quad-tree or binary-tree pattern.

Here, the encoding target block may be a coding unit, each of the sub-blocks may be a prediction unit included in the coding unit, and partition form of the coding unit may be determined based on a prediction mode.

Here, the processing order may be determined based on an intra-prediction mode of the prediction unit or an inter-prediction mode of the prediction unit.

According to another aspect of the present invention, there is provided a method for decoding a video signal, the method including: partitioning a decoding target block into a plurality of sub-blocks; determining a processing order of the sub-blocks included in the decoding target block; and decoding the sub-blocks in series based on the processing order.

Here, the decoding of the sub-blocks in series may include: determining a sub-block having a processing order related to a current order among the sub-blocks; decoding the sub-block; and increasing the current order when the sub-block is not a last sub-block in the decoding target block.

Here, when there is a plurality of sub-blocks having a processing order related to the current order, the sub-blocks having a same ranking in the processing order may be decoded in parallel.

Here, when there is a plurality of sub-blocks to be decoded in the current order, the processing order of the sub-blocks having a same ranking in the processing order may be determined based on a raster scanning order or a zigzag scanning order.

Here, the processing order may be determined based on information of the processing order that is entropy decoded from a bitstream, and the information of the processing order may include a flag indicating whether a sub-block is decoded in the current order.

Here, the processing order may be determined based on at least one of sizes of the sub-blocks, locations of the sub-blocks, or prediction modes for the sub-blocks.

Here, the processing order of a sub-block may be determined to precede when the size of the sub-block is larger than other sub-blocks.

Here, the processing order of a sub-block encoded in inter prediction may be determined to precede the processing order of a sub-block encoded in intra prediction.

According to still another aspect of the present invention, there is provided an apparatus for encoding a video signal, the apparatus including: a prediction unit partitioning an encoding target block into a plurality of sub-blocks and determining a processing order of the sub-blocks included in the encoding target block; and an entropy decoding unit entropy decoding information of the processing order of the sub-blocks.

In addition, according to yet still another aspect of the present invention, there is provided an apparatus for decoding a video signal, the apparatus including: a prediction unit partitioning a decoding target block into a plurality of sub-blocks, determining a processing order of the sub-blocks included in the decoding target block, and decoding the sub-blocks in series based on the processing order.

It is to be understood that the foregoing summarized features are exemplary aspects of the following detailed description of the present invention without limiting the scope of the present invention.

### Advantageous Effects

As described above, according to the present invention, it is possible to provide a method and apparatus for designating the processing order of units, thereby enhancing video encoding/decoding efficiency.

Specifically, according to the present invention, it is possible to provide a method and apparatus for determining the processing order of units in a video encoding process, and for successively processing the units in a video decoding process according to the processing order determined in the encoding process.

Effects that may be obtained from the present invention will not be limited to only the above described effects. In addition, other effects which are not described herein will become apparent to those skilled in the art from the following description.

### DESCRIPTION OF DRAWINGS

FIG. 1 is a block diagram showing configurations of an encoding apparatus according to an embodiment of the present invention.

FIG. 2 is a block diagram showing configurations of a decoding apparatus according to an embodiment of the present invention.

FIG. 3 is a view schematically showing a partition structure of an image when encoding and decoding the image.

FIG. 4 is a view showing patterns of a prediction unit (PU) that may be included in a coding unit (CU).

FIG. 5 is a view showing patterns of a transform unit (TU) that may be included in a coding unit (CU).

FIG. 6 is a flowchart showing a method for encoding an image frame according to an embodiment of the present invention.

FIG. 7 is a view showing an encoding method for designating a processing order of coding units in a coding tree unit according to an embodiment of the present invention.

FIG. 8 is a flowchart showing a method for encoding a coding unit according to an embodiment of the present invention.

FIG. 9 is a flowchart showing a method for decoding an image frame according to an embodiment of the present invention.

FIG. 10 is a view showing an example of determining a decoding order for a decoding target unit.

FIG. 11 is a flowchart showing a method for decoding a coding tree unit according to an embodiment of the present invention.

FIG. 12 is a flowchart showing a method for decoding a coding unit according to an embodiment of the present invention.

FIG. 13 is a view showing locations of both a current block and reference samples of the current block according to an embodiment of the present invention.

FIG. 14 is a flowchart showing a method for encoding a current block according to an embodiment of the present invention.

FIGS. 15 and 16 are views for explaining an example of replacing an unusable sample.

FIG. 17 is a view showing an example of performing intra prediction based on a planar mode.

FIG. 18 is a view showing an intra-prediction direction based on a uni-directional prediction mode.

FIG. 19 is a view showing an intra-prediction direction based on a uni-directional prediction mode.

FIG. 20 is a view showing an intra-prediction direction based on a bi-directional prediction mode.

FIG. 21 is a view showing an example of generating a prediction sample in a bi-directional prediction mode.

### MODE FOR INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range equivalent to what the claims claim.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention and the ‘second’ component may also be similarly named the ‘first’ component. The term ‘and/or’ includes a combination of a plurality of items or any one of a plurality of terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than the corresponding element are not excluded, but additional elements may be included in embodiments of the present invention or the scope of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

In addition, hereinafter, an image may mean a picture configuring a video, or may mean the video itself. For example, “encoding or decoding or both of an image” may mean “encoding or decoding or both of a video”, and may mean “encoding or decoding or both of one image among images of a video.” Here, a picture and the image may have the same meaning.

The following definitions are provided for specific terms that are used in the description.

Encoder: may mean an apparatus performing encoding.

Decoder: may mean an apparatus performing decoding.

Parsing: may mean determination of a value of a syntax element by performing entropy decoding, or may mean the entropy decoding itself.

Block: may mean a sample of an M×N matrix. Here, M and N are positive integers. The block may mean a sample matrix in a two-dimensional form.

Sample: is a basic unit of a block, and may indicate a value ranging 0 to 2 Bd−1 depending on the bit depth (Bd). The sample may mean a pixel in the present invention.

Unit: may mean a unit of encoding and decoding of an image. In encoding and decoding an image, the unit may be an area generated by partitioning one image. In addition, the unit may mean a subdivided unit when one image is partitioned into subdivided units during encoding or decoding. In encoding and decoding an image, a predetermined process for each unit may be performed. One unit may be partitioned into sub units that have sizes smaller than the size of the unit. Depending on functions, the unit may mean a block, a macroblock, a coding tree unit, a coding tree block, a coding unit, a coding block, a prediction unit, a prediction block, a transform unit, a transform block, etc. In addition, in order to distinguish a unit from a block, the unit may include a luma component block, a chroma component block of the luma component block, and a syntax element of each color component block. The unit may have various sizes and shapes, and particularly, the shape of the unit may be a two-dimensional geometrical figure such as a rectangular shape, a square shape, a trapezoid shape, a triangular shape, a pentagonal shape, etc. In addition, unit information may include at least one of a unit type indicating the coding unit, the prediction unit, the transform unit, etc., and a unit size, a unit depth, a sequence of encoding and decoding of a unit, etc.

Reconstructed Neighbor Unit: may mean a reconstructed unit that is previously spatially/temporally encoded or decoded, and the reconstructed unit is adjacent to an encoding/decoding target unit.

Unit Depth: may mean a partitioned degree of a unit. In a tree structure, a root node may be the highest node, and a leaf node may be the lowest node.

Symbol: may mean a syntax element of the encoding/decoding target unit, a coding parameter, a value of a transform coefficient, etc.

Parameter Set: may mean header information in a structure of the bitstream. The parameter set may include at least one of a video parameter set, a sequence parameter set, a picture parameter set, or an adaptation parameter set. In addition, the parameter set may mean slice header information and/or tile header information, etc.

Bitstream: may mean a bit string including encoded image information.

Prediction Unit: may mean a basic unit when performing inter prediction or intra prediction, and compensation for the prediction. One prediction unit may be partitioned into a plurality of partitions. In this case, each of the plurality of partitions may be a basic unit while performing the predictions and the compensation. Therefore, each partition partitioned from the prediction unit may be a prediction unit. In addition, one prediction unit may be partitioned into a plurality of small prediction units. A prediction unit may have various sizes and shapes, and particularly, the shape of the prediction unit may be a two-dimensional geometrical figure such as a rectangular shape, a square shape, a trapezoid shape, a triangular shape, a pentagonal shape, etc.

Prediction Unit Partition: may mean the shape of a partitioned prediction unit.

Reference Picture List: may mean a list including at least one reference picture that is used for inter prediction or motion compensation. Types of the reference picture list may be List Combined (LC), List 0 (L0), List 1 (L1), List 2 (L2), List 3 (L3), etc. At least one reference picture list may be used for inter prediction.

Inter Prediction Indicator: may mean one of the inter-prediction direction (one-way directional prediction, bidirectional prediction, etc.) of an encoding/decoding target block in a case of inter prediction, the number of reference pictures used for generating a prediction block by the encoding/decoding target block, and the number of reference blocks used for performing inter prediction or motion compensation by the encoding/decoding target block.

Reference Picture Index: may mean an index of a specific reference picture in the reference picture list.

Reference Picture: may mean a picture to which a specific unit refers for inter prediction or motion compensation. A reference image may be referred to as the reference picture.

Motion Vector: is a two-dimensional vector used for inter prediction or motion compensation, and may mean an offset between an encoding/decoding target picture and the reference picture. For example, (mvX, mvY) may indicate the motion vector, mvX may indicate a horizontal component, and mvY may indicate a vertical component.

Motion Vector Candidate: may include at least one of information, the reference picture, the motion vector candidate, the motion vector candidate index, etc., and may mean a unit that becomes a prediction candidate when predicting the motion vector, or may mean a motion vector of the unit.

Motion Vector Candidate List: may mean a list configured by using the motion vector candidate.

Motion Vector Candidate Index: may mean an indicator that indicates the motion vector candidate in the motion vector candidate list. The motion vector candidate index may be referred to as an index of a motion vector predictor.

Motion Information: may include the motion vector, the reference picture index, and/or the inter-prediction indicator, etc. In addition, the motion information may include reference picture list information.

Merge Candidate List: may mean a list configured by using the merge candidate.

Merge Candidate: may include a spatial merge candidate, a temporal merge candidate, a combined merge candidate, a combined bi-prediction merge candidate, a zero merge candidate, etc. The merge candidate may include motion information such as prediction type information, a reference picture index for each list, a motion vector, etc.

Merge Index: may mean information indicating the merge candidate in the merge candidate list. In addition, the merge index may indicate a block, which induces the merge candidate, among reconstructed blocks spatially/temporally adjacent to the current block. In addition, the merge index may indicate at least one of pieces of motion information of the merge candidate.

Transform Unit: may mean a basic unit when performing encoding/decoding of a residual signal, similar to transform, inverse transform, quantization, dequantization and/or transform coefficient encoding/decoding. One transform unit may be partitioned into a plurality of small transform units. The transform unit may have various sizes and shapes. Particularly, the shape of the transform unit may be a two-dimensional geometrical figure such as a rectangular shape, a square shape, a trapezoid shape, a triangular shape, a pentagonal shape, etc.

Scaling: may mean a process of multiplying a factor to a transform coefficient level, and as a result, a transform coefficient may be generated. The scaling may be also referred to as dequantization.

Quantization Parameter: may mean a value used in scaling the transform coefficient level during quantization and dequantization. Here, the quantization parameter may be a value mapped to a step size of the quantization.

Delta Quantization Parameter: may mean a residual value between a predicted quantization parameter and a quantization parameter of the encoding/decoding target unit.

Scan: may mean a method of sorting coefficient orders within a block or a matrix. For example, sorting a two-dimensional matrix into a one-dimensional matrix may be referred to as scanning, and sorting a one-dimensional matrix into a two-dimensional matrix may be referred to as scanning or inverse scanning.

Transform Coefficient: may mean a coefficient value generated after performing a transform. A quantized transform coefficient level that is a transform coefficient to which the quantization is applied may be referred to as the transform coefficient.

Non-zero Transform Coefficient: may mean a transform coefficient in which a value thereof is not 0, or may mean a transform coefficient level in which a value thereof is not 0.

Quantization Matrix: may mean a matrix used in quantization and dequantization in order to enhance subject quality or object quality of an image. The quantization matrix may be referred to as a scaling list.

Quantization Matrix Coefficient: may mean each element of a quantization matrix. The quantization matrix coefficient may be referred to as a matrix coefficient.

Default Matrix: may mean a predetermined quantization matrix that is defined in the encoder and the decoder in advance.

Non-default Matrix: may mean a quantization matrix that is transmitted/received by a user without being previously defined in the encoder and the decoder.

Based on the above-described descriptions, descriptions of the present invention will be disclosed in detail.

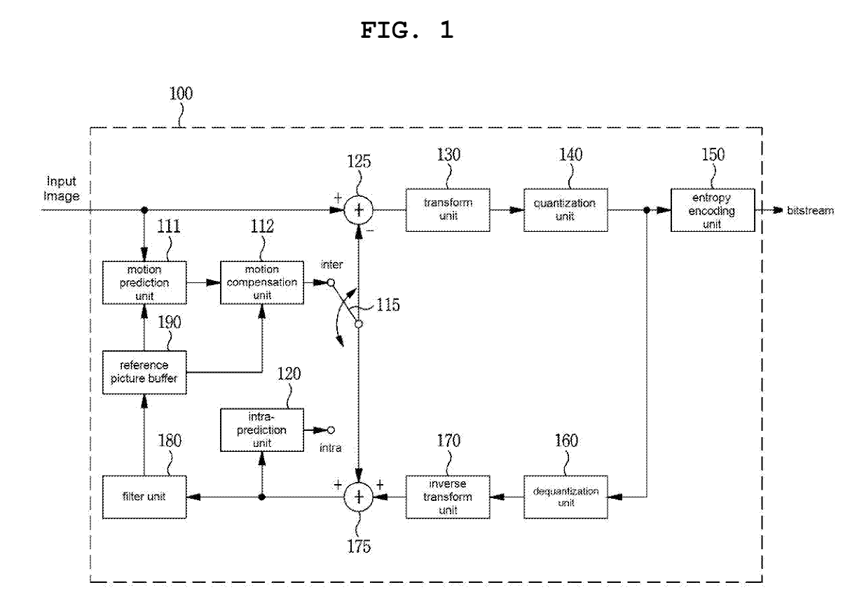

FIG. 1 is a block diagram showing configurations of an encoding apparatus according to an embodiment of the present invention.

The encoding apparatus 100 may be a video encoding apparatus or an image encoding apparatus. Here, a video may include one or more images. The encoding apparatus 100 may encode the one or more images of the video in order of time.

Referring to FIG. 1, the encoding apparatus 100 may include a motion prediction unit 111, a motion compensation unit 112, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180, and a reference picture buffer 190.

The encoding apparatus 100 may encode an input picture in an intra mode or an inter mode or both. In addition, the encoding apparatus 100 may generate a bitstream by encoding the input picture, and may output the generated bitstream. When the intra mode is used as a prediction mode, the switch 115 may be switched to intra. When the inter mode is used as a prediction mode, the switch 115 may be switched to inter. Here, the intra mode may be referred to as an intra-prediction mode, and the inter mode may be referred to as an inter-prediction mode. The encoding apparatus 100 may generate a prediction block of an input block of the input picture. In addition, after generating the prediction block, the encoding apparatus 100 may encode residuals between the input block and the prediction block. The input picture may be referred to as a current image (or a current picture) that is a target of current encoding. The input block may be referred to as a current block or as an encoding target block that is a target of the current encoding.

When the prediction mode is the intra mode, the intra-prediction unit 120 may use a pixel value of a previously encoded block, which is adjacent to the current block, as a reference pixel. The intra-prediction unit 120 may perform spatial prediction by using the reference pixel, and may generate prediction samples of the input block by using the spatial prediction. Here, intra prediction may mean intra-frame prediction.

When the prediction mode is the inter mode, the motion prediction unit 111 may search for a region that is optimally matched with the input block from a reference picture in a motion predicting process, and may derive a motion vector by using the searched region. The reference picture may be stored in the reference picture buffer 190.

The motion compensation unit 112 may generate the prediction block by performing motion compensation using the motion vector. Here, the motion vector may be a two-dimensional vector that is used for inter prediction. In addition, the motion vector may indicate offset between the current picture and the reference picture. Here, inter prediction may be mean inter-frame prediction. When a value of the motion vector is not an integer, the motion prediction unit 111 and the motion compensation unit 112 may generate the prediction block by applying an interpolation filter to a partial region in the reference picture.

In order to perform inter prediction or motion compensation, the motion prediction and motion compensation method of a prediction unit may be determined. Here, the motion prediction and motion compensation method of a prediction unit may be determined as in at least one of a skip mode, a merge mode, and an AMVP mode. The motion prediction unit 111 and the motion compensation unit 112 may perform inter prediction or motion compensation of the prediction unit depending on the modes. Here, the motion prediction and motion compensation method may be determined on the basis of the coding unit. In this case, the motion prediction and motion compensation method determined for a coding unit may be applied to the prediction unit of the coding unit.

The subtractor 125 may generate a residual block by using the residuals between the input block and the prediction block. The residual block may be referred to as a residual signal.

The transform unit 130 may generate a transform coefficient by transforming the residual block, and may output the transform coefficient. Here, the transform coefficient may be a coefficient value generated by transforming the residual block. In a transform skip mode, the transform unit 130 may skip the transforming of the residual block.

A quantized transform coefficient level may be generated by applying quantization to the transform coefficient. Hereinafter, the quantized transform coefficient level may be referred to as the transform coefficient in the embodiment of the present invention.

The quantization unit 140 may generate the quantized transform coefficient level by quantizing the transform coefficient depending on the quantization parameter, and may output the quantized transform coefficient level. Here, the quantization unit 140 may quantize the transform coefficient by using a quantization matrix.

According to the probability distribution, the entropy encoding unit 150 may generate the bitstream by performing entropy encoding on values calculated by the quantization unit 140 or on coding parameter values calculated in an encoding process, etc., and may output the generated bitstream. The entropy encoding unit 150 may perform the entropy encoding on information for decoding an image, and on information of a pixel of an image. For example, the information for decoding an image may include a syntax element, etc.

When the entropy encoding is applied, symbols are represented by allocating a small number of bits to the symbols having high occurrence probability and allocating a large number of bits to the symbols having low occurrence probability, thereby reducing the size of the bitstream of encoding target symbols. Therefore, compression performance of the image encoding may be increased through the entropy encoding. For the entropy encoding, the entropy encoding unit 150 may use an encoding method such as exponential golomb, context-adaptive variable length coding (CAVLC), and context-adaptive binary arithmetic coding (CABAC). For example, the entropy encoding unit 150 may perform the entropy encoding by using variable length coding/code (VLC) table. In addition, the entropy encoding unit 150 may derive a binarization method of the target symbol and a probability model of the target symbol/bin, and may perform arithmetic coding by using the derived binarization method or the derived probability model thereafter.

In order to encode the transform coefficient level, the entropy encoding unit 150 may change a two-dimensional block form coefficient into a one-dimensional vector form by using a transform coefficient scanning method. For example, the two-dimensional form coefficient may be changed into the one-dimensional vector form by scanning the coefficient of the block with at least one of up-right scanning, vertical direction scanning, or horizontal direction scanning. Here, the vertical direction scanning is scanning the two-dimensional block form coefficient in a column direction, and the horizontal direction is scanning the two-dimensional block form coefficient in a row direction. The scanning direction may be determined based on at least one of the size of the unit and the intra-prediction mode. Here, the unit may mean a coding unit, a transform unit, or a prediction unit. For example, it is possible to determine which scanning method among up-right scanning, vertical direction scanning, and horizontal direction scanning is to be used depending on the size of the transform unit and the intra-prediction mode.

The coding parameter may include information, such as the syntax element, which is encoded by the encoder and is transmitted to the decoder, and may include information that may be derived in the encoding or decoding process. The coding parameter may mean information that is necessary to encode or decode an image. For example, the coding parameter may include at least one of the intra-prediction mode, the inter-prediction mode, the intra-prediction direction, the motion information, the motion vector, reference picture index, the inter-prediction direction, the inter-prediction indicator, the reference picture list, the motion vector predictor, the motion merge candidate, the type of transform, the size of transform, the information about whether or not an additional transform is used, the filter information within a loop, the information about whether or not a residual signal is present, the quantization parameter, the context model, the transform coefficient, transform coefficient level, the coded block pattern, the coded block flag, the image display/output order, the slice information, the tile information, the picture type, the information about whether or not the motion merge mode is used, the information about whether or not the skip mode is used, the block size, the block depth, the block partition information, the unit size, the unit depth, and the value of the unit partition information, etc. or the statistics thereof or both.

The residual signal may mean the difference between the original signal and the prediction signal. Alternatively, the residual signal may be a signal generated by transforming the difference between the original signal and the prediction signal. Alternatively, the residual signal may be a signal generated by transforming and quantizing the difference between the original signal and the prediction signal. The residual block may be the residual signal of a block unit.

When the encoding apparatus 100 performs encoding by using inter prediction, the current picture may be used as a reference picture for another image(s) that will be processed thereafter. In order to use the current picture as a reference picture of another image, the encoding apparatus 100 may decode the encoded current picture, and may store the decoded image as the reference picture. In order to perform the decoding, dequantization and inverse transform may be performed on the encoded current picture.

A quantized coefficient may be dequantized by the dequantization unit 160, and may be inversely transformed by the inverse transform unit 170. The dequantized and inversely transformed coefficient may be added to the prediction block by the adder 175, whereby a reconstructed block may be generated.

The reconstructed block may pass the filter unit 180. The filter unit 180 may apply at least one of a deblocking filter, a sample adaptive offset (SAO), and an adaptive loop filter (ALF) to the reconstructed block or a reconstructed picture. The filter unit 180 may be referred to as an in-loop filter.

The deblocking filter may remove block distortion that occurs at boundaries between the blocks. In order to determine whether or not the deblocking filter is operated, it is possible to determine whether or not the deblocking filter is applied to the current block on the basis of the pixels included in several rows or columns in the block. When the deblocking filter is applied to the block, a strong filter or a weak filter may be applied depending on required deblocking filtering strength. In addition, in applying the deblocking filter, horizontal direction filtering and vertical direction filtering may be processed in parallel.

The sample adaptive offset may add an optimum offset value to the pixel value or may subtract the optimum offset value from the pixel value in order to compensate for an encoding error. The sample adaptive offset may correct an offset between the deblocking filtered image and the original picture for each pixel. In order to perform the offset correction on a specific picture, it is possible to use a method of applying an offset correction in consideration of edge information of each pixel or a method of partitioning pixels of an image into the predetermined number of regions, determining a region to be subjected to perform an offset correction, and applying the offset correction to the determined region.

The adaptive loop filter may perform filtering on the basis of a value obtained by comparing the reconstructed picture and the original picture. Pixels of an image may be partitioned into predetermined groups, one filter being applied to each of the groups is determined, and different filtering may be performed at each of the groups. Information about whether or not the adaptive loop filter is applied may be transmitted for each coding unit (CU), transform unit, prediction unit, or coding tree unit. In addition, the information about whether or not the adaptive loop filter is applied may be transmitted for each color component. For example, information about whether or not the adaptive loop filter is applied to the luma signal may be transmitted for each coding unit. A shape and a filter coefficient of an adaptive loop filter being applied to each block may vary. In addition, an adaptive loop filter having the same form (fixed form) may be applied regardless of characteristics of a target block.

The reconstructed block that passed the filter unit 180 may be stored in the reference picture buffer 190.

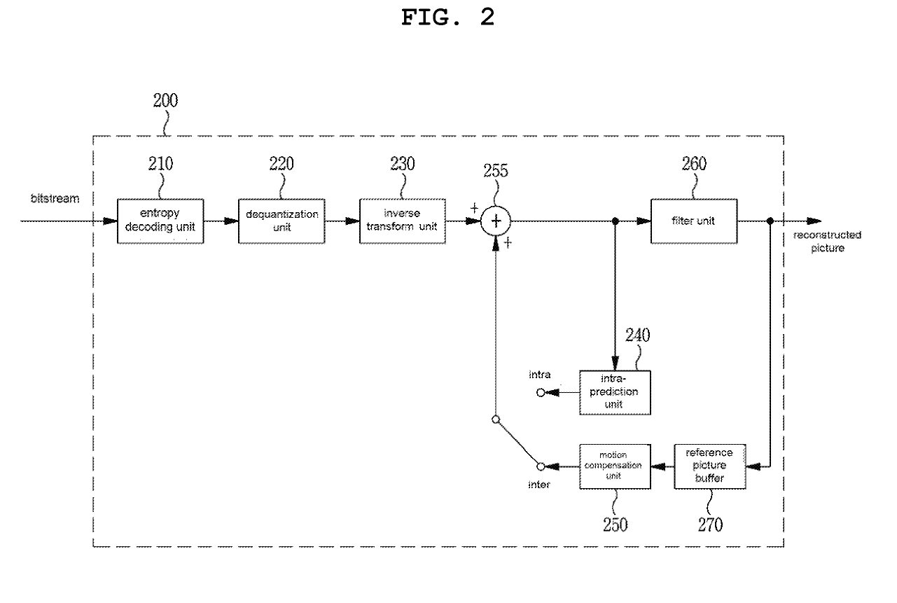

FIG. 2 is a block diagram showing configurations of a decoding apparatus according to an embodiment of the present invention.

The decoding apparatus 200 may be a video decoding apparatus or an image decoding apparatus.

Referring to FIG. 2, the decoding apparatus 200 may include an entropy decoding unit 210, a dequantization unit 220, an inverse transform unit 230, an intra-prediction unit 240, a motion compensation unit 250, an adder 255, a filter unit 260, and a reference picture buffer 270.

The decoding apparatus 200 may receive the bitstream outputted from the encoding apparatus 100. The decoding apparatus 200 may decode the bitstream in the intra mode or the inter mode. In addition, the decoding apparatus 200 may generate a reconstructed picture by performing decoding, and may output the reconstructed picture.

When a prediction mode used in decoding is the intra mode, the switch may be switched to intra. When the prediction mode used in decoding is the inter mode, the switch may be switched to inter.

The decoding apparatus 200 may obtain the reconstructed residual block from the inputted bitstream, and may generate the prediction block. When the reconstructed residual block and the prediction block are obtained, the decoding apparatus 200 may generate the reconstructed block, which is a decoding target block, by adding the reconstructed residual block and the prediction block. The decoding target block may be referred to as a current block.

The entropy decoding unit 210 may generate symbols by performing entropy decoding on the bitstream according to the probability distribution. The generated symbols may include a symbol having a quantized transform coefficient level. Here, a method of entropy decoding may be similar to the above-described method of the entropy encoding. For example, the method of the entropy decoding may be an inverse process of the above-described method of the entropy encoding.

In order to decode the transform coefficient level, the entropy decoding unit 210 may perform transform coefficient scanning. The one-dimensional vector form coefficient may be changed into the two-dimensional block form through the transform coefficient scanning. For example, the one-dimensional vector form coefficient may be changed into a two-dimensional block form by scanning the coefficient of the block with at least one of up-right scanning, vertical direction scanning, or horizontal direction scanning. The scanning direction may be determined depending on at least one of the size of the unit and the intra-prediction mode. Here, the unit may mean the coding unit, the transform unit, or the prediction unit. For example, it is possible to determine which scanning method among up-right scanning, vertical direction scanning, and horizontal direction scanning is used depending on the size of the transform unit and the intra-prediction mode.

The quantized transform coefficient level may be dequantized by the dequantization unit 220, and may be inversely transformed by the inverse transform unit 230. The quantized transform coefficient level is dequantized and is inversely transformed so as to generate a reconstructed residual block. Here, the dequantization unit 220 may apply the quantization matrix to the quantized transform coefficient level.

When the intra mode is used, the intra-prediction unit 240 may generate a prediction block by performing the spatial prediction that uses the pixel value of the previously decoded block that is adjacent to the decoding target block.

When the inter mode is used, the motion compensation unit 250 may generate the prediction block by performing motion compensation that uses both the motion vector and the reference picture stored in the reference picture buffer 270. When the value of the motion vector is not an integer, the motion compensation unit 250 may generate the prediction block by applying the interpolation filter to the partial region in the reference picture.

In order to perform motion compensation, it is possible to determine the motion prediction and the motion compensation method of the prediction unit. Here, the motion prediction and the motion compensation method of the prediction unit may be determined as at least one of the skip mode, the merge mode, the AMVP mode. The intra-prediction unit 240 and the motion compensation unit 250 may perform the inter prediction or the motion compensation for the prediction unit depending on the determined method. Here, the motion prediction and the motion compensation method may be determined on the basis of the coding unit. In this case, the motion prediction and the motion compensation determined for a coding unit may be applied to a prediction unit included in the coding unit.

The reconstructed residual block may be added to the prediction block by the adder 255. A block generated by adding the reconstructed residual block and the prediction block may pass the filter unit 260. The filter unit 260 may apply at least one of the deblocking filter, the sample adaptive offset, and the adaptive loop filter to the reconstructed block or to the reconstructed picture. The filter unit 260 may output the reconstructed picture. The reconstructed picture may be stored in the reference picture buffer 270, and may be used for inter prediction.

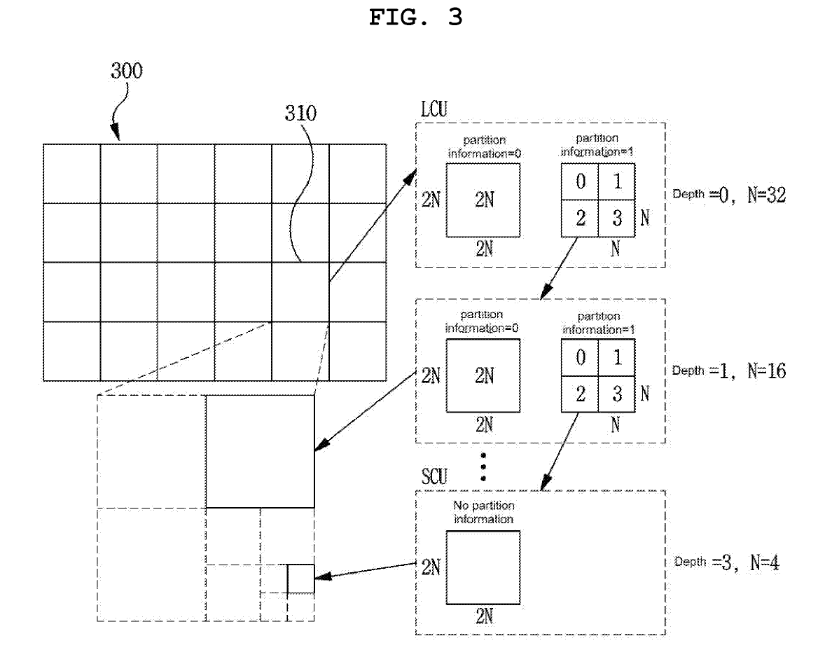

FIG. 3 is a view schematically showing a partition structure of an image when encoding and decoding the image. FIG. 3 schematically shows an embodiment of partitioning one unit into a plurality of sub-units.

In order to efficiently partition an image, an encoding unit (or coding unit; CU) may be used in encoding and decoding. Here, the unit may be a combination of 1) a syntax element and 2) a block including image samples. For example, “partition of a unit” may mean “partition of a block relative to a unit”. The block partition information may include information about the unit depth. Depth information may indicate the number of time a unit is partitioned or a partitioned degree of a unit or both.

Referring to FIG. 3, an image 300 is sequentially partitioned for each largest coding unit (LCU), and a partition structure is determined for each LCU. Here, the LCU and a coding tree unit (CTU) have the same meaning. One unit may have depth information based on a tree structure, and may be hierarchically partitioned. Each of the partitioned sub-units may be depth information. The depth information indicates the number of times a unit is partitioned or a partitioned degree of a unit or both, and thus, the depth information may include information about the size of the sub-unit.

The partition structure may mean distribution of a coding unit (CU) in the LCU 310. The CU may be a unit for efficiently encoding an image. The distribution may be determined on the basis of whether or not one CU will be partitioned in plural (a positive integer equal to or more than 2 including 2, 4, 8, 16, etc.). A width size and/or a height size of the partitioned CU may respectively be less than a width size and/or a height size of the original CU. For example, in FIG. 3, the width size and/or the height size of the partitioned CU may respectively be a half width size and/or a half height size of the original CU. Alternatively, the width size and the height size of the partitioned CU may respectively be one-half, one-third, one-quarter, etc. of the width size and the height size of the original CU. The partitioned CU may be recursively partitioned into a plurality of further partitioned CUs, wherein the further partitioned CU has a width size and a height size smaller than those of the partitioned CU in the same partition method or in the different partition method.

The partition of a CU may be recursively performed up to a predetermined depth. Depth information may be information indicating a size of the CU, and may be stored in each CU. For example, the depth of the LCU may be 0, and the depth of a smallest coding unit (SCU) may be a predetermined maximum depth. Here, the LCU may be a coding unit having a maximum size as described above, and the SCU may be a coding unit having a minimum size.

FIG. 3 shows an embodiment of partitioning one CU into four sub-CUs. Referring to FIG. 3, whenever the LCU 310 begins to be partitioned, and the width size and the height size of the CU are decreased by the partitioning, the depth of a CU is increased by 1. In a case of a CU which cannot be partitioned, the CU may have a 2N×2N size for each depth. In a case of a CU that can be partitioned, the CU having a 2N×2N size may be partitioned into a plurality of N×N-size CUs. The size of N is reduced by half whenever the depth is increased by 1.

For example, when one coding unit is partitioned into four sub-coding units, a width size and a height size of one of the four sub-coding units may respectively be a half width size and a half height size of the original coding unit. For example, when a 32×32-size coding unit is partitioned into four sub-coding units, each of the four sub-coding units may have a 16×16 size. When one coding unit is partitioned into four sub-coding units, the coding unit may be partitioned in a quad-tree pattern.

Referring to FIG. 3, the size of the LCU having a minimum depth of 0 may be 64×64 pixels, and the size of the SCU having a maximum depth of 3 may be 8×8 pixels. Here, a CU having 64×64 pixels, which is the LCU, may be denoted by a depth of 0, a CU having 32×32 pixels may be denoted by a depth of 1, a CU having 16×16 pixels may be denoted by a depth of 2, and a CU having 8×8 pixels, which is the SCU, may be denoted by a depth of 3.

Not shown in FIG. 3, one CU may be partitioned into sub-CUs, of which the number is less than or larger than four. For example, when one coding unit is partitioned into two sub-coding units, a width size or a height size of one of the two sub-coding units may respectively be a half width size or a half height size of the original coding unit. For example, when a 32×32-size coding unit is vertically partitioned into two sub-coding units, each of the two sub-coding units may have a 16×32 size. For example, when a 32×32-size coding unit is horizontally partitioned into two sub-coding units, each of the two sub-coding units may have a 32×16 size. When one coding unit is partitioned into two sub-coding units, the coding unit may be partitioned in a binary-tree pattern.

Information about whether or not a CU will be partitioned may be represented through partition information of a CU. The partition information may be 1 bit information. The partition information may be included in all CUs other than the SCU. For example, when a value of the partition information is 0, a CU may not be partitioned, and when a value of the partition information is 1, a CU may be partitioned. Here, information indicating whether partition is performed in the quad-tree pattern and information indicating whether partition is performed in the binary-tree pattern may be individually signaled for each CU.

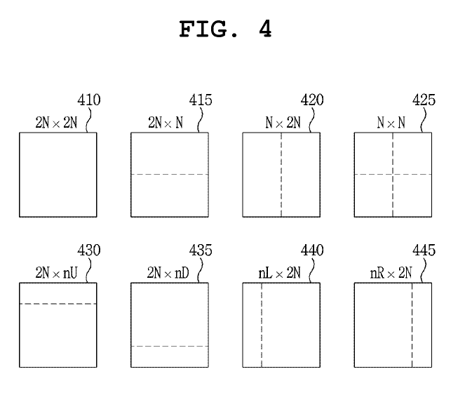

FIG. 4 is a view showing patterns of a prediction unit (PU) that may be included in a coding unit (CU).

A CU that is no longer partitioned, from among CUs partitioned from the LCU, may be partitioned into at least one prediction unit (PU). This process may be also referred to as a partition.

The PU may be a basic unit for prediction. The PU may be encoded and decoded in any one of a skip mode, an inter mode, and an intra mode. The PU may be partitioned in various patterns depending on the modes.

In addition, the coding unit may not be partitioned into a plurality of prediction units. In this case, the coding unit and the prediction unit have the same size.

Partition pattern of the CU will be described with reference to FIG. 4.

In the skip mode, the CU may not be partitioned. Therefore, in the skip mode, a 2N×2N mode 410 having the same size as a CU without partition may be supported.

In the inter mode, 8 partitioned patterns may be supported within a CU, for example, the 2N×2N mode 410, a 2N×2N mode 415, an N×2N mode 420, an N×N mode 425, a 2N×nU mode 430, a 2N×nD mode 435, an nL×2N mode 440, and an nR×2N mode 445.

In the intra mode, the 2N×2N mode 410 and the N×N mode 425 may be supported.

The partition patterns supported by the skip mode, the inter mode, and the intra mode are not limited to the described example. In addition, the CU may be partitioned in different patterns of FIG. 4.

As described above, one coding unit may be partitioned into one or more prediction units. One prediction unit may be partitioned into one or more sub-prediction units.

For example, when one prediction unit is partitioned into four sub-prediction units, a width size and a height size of one of the four sub-prediction units may be a half width size and a half height size of the original prediction unit. For example, when a 32×32-size prediction unit is partitioned into four sub-prediction units, each of the four sub-prediction units may have a 16×16 size. When one prediction unit is partitioned into four sub-prediction units, the prediction unit may be partitioned in the quad-tree pattern.

For example, when one prediction unit is partitioned into two sub-prediction units, a width size or a height size of one of the two sub-prediction units may be a half width size or a half height size of the original prediction unit. For example, when a 32×32-size prediction unit is vertically partitioned into two sub-prediction units, each of the two sub-prediction units may have a 16×32 size. For example, when a 32×32-size prediction unit is horizontally partitioned into two sub-prediction units, each of the two sub-prediction units may have a 32×16 size. When one prediction unit is partitioned into two sub-prediction units, the prediction unit may be partitioned in the binary-tree pattern.

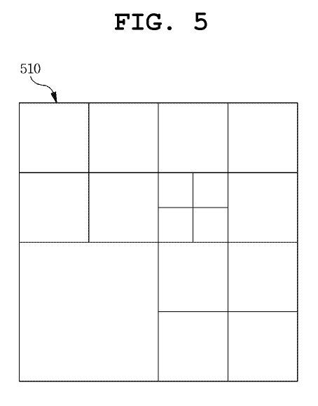

FIG. 5 is a view showing patterns of a transform unit (TU) that may be included in a coding unit (CU).

A transform unit (TU) may be a basic unit used for a transform, quantization, a reverse transform, and dequantization within a CU. The TU may have a square shape or a rectangular shape, etc. The TU may be dependently determined by a size of a CU or a pattern of a CU or both.

A CU that is no longer partitioned among CUs partitioned from the LCU may be partitioned into at least one TU. Here, the partition structure of the TU may be a quad-tree structure. For example, as shown in FIG. 5, one CU 510 may be partitioned once or more depending on the quad-tree structure. The case where one CU is partitioned at least once may be referred to as recursive partition. Through the partitioning, one CU 510 may be formed of TUs having various sizes.

A CU may be partitioned into at least one TU depending on the number of vertical lines partitioning the CU or the number of horizontal lines partitioning the CU or both. The CU may be partitioned into TUs that are symmetrical to each other, or may be partitioned into TUs that are asymmetrical to each other. When the CU is partitioned into TUs that are symmetrical to each other, information of a size/shape of the TU may be signaled. As another example, the information of the size/shape of the TU may be derived from information of a size/shape of the CU.

The coding unit may not be partitioned into a plurality of transform units. In this case, the coding unit and the transform unit may have the same size.

As described above, one coding unit may be partitioned into at least one transform unit. In addition, one transform unit may be partitioned into at least one sub-transform unit.

For example, when one transform unit is partitioned into four sub-transform units, a width size and a height size of one of the four sub-transform units may respectively be a half width size and a half height size of the original transform unit. For example, when a 32×32-size transform unit is partitioned into four sub-transform units, each of the four sub-transform units may have a 16×16 size. When one transform unit is partitioned into four sub-transform units, the transform unit may be partitioned in the quad-tree pattern.

For example, when one transform unit is partitioned into two sub-transform units, a width size or a height size of one of the two sub-transform units may respectively be a half width size or a half height size of the original transform unit. For example, when a 32×32-size transform unit is vertically partitioned into two sub-transform units, each of the two sub-transform units may have a 16×32 size. For example, when a 32×32-size transform unit is horizontally partitioned into two sub-transform units, each of the two sub-transform units may have a 32×16 size. When one transform unit is partitioned into two sub-transform units, the transform unit may be partitioned in the binary-tree pattern.

When transform is performed on the transform unit, the residual block may be transformed by using at least one of predetermined transform methods. Here example, the predetermined transform methods may include discrete cosine transform (DCT), discrete sine transform (DST), Karhunen-Loève transform (KLT), etc. A transformation method of the residual block may be determined by using at least one of inter-prediction mode information of the prediction unit, intra-prediction mode information of the prediction unit, and size/shape of the block. Here, the block may mean at least one of the transform block, the prediction block, and the coding block. As another example, the transformation method of the residual block may be indicated by information signaled from the encoder.

A method of determining a processing order of an encoding/decoding target unit will be described in detail based on the above-described description. Here, the encoding/decoding target unit may be referred to as an ‘encoding/decoding target block’. In addition, units included in the encoding/decoding target unit may be referred to as ‘sub-units’ or ‘sub-blocks’.

For convenience of description, the following embodiment describes a processing order of coding units in one coding tree unit or a processing order of prediction units or transform units in one coding unit. However, the following embodiment may be applied to encode/decode a processing order of encoding tree units in a slice or a tile, and a processing order of slices or tiles in a picture.

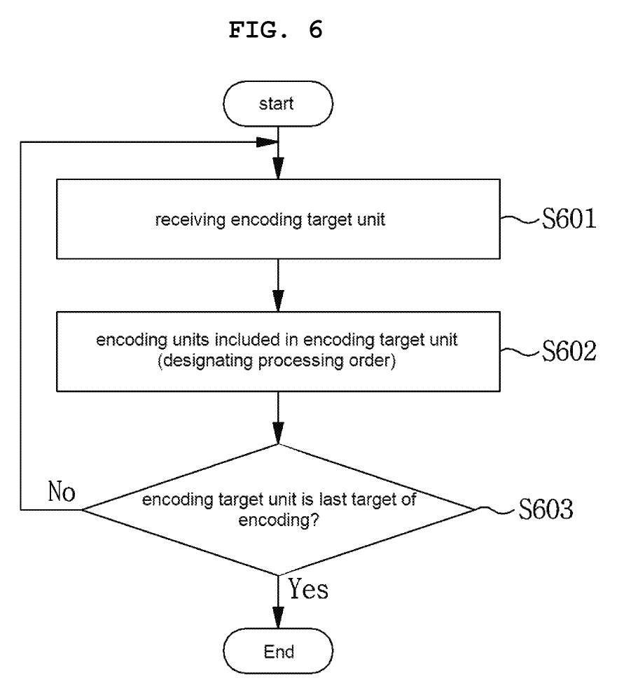

FIG. 6 is a flowchart showing a method for encoding an image frame according to an embodiment of the present invention. Specifically, FIG. 6 is a flowchart showing an encoding method for designating a processing order of units. Here, the processing order is a decoding order. In addition, the embodiment may relate to a processing order of coding units included in the coding tree unit, or to a processing order of prediction units or of transform units included in a coding unit.

First, the encoding apparatus receives an encoding target unit at step S601. Here, the encoding target unit may include a coding tree unit or a coding unit, etc. At this step, the encoding apparatus may receive one coding tree unit or coding unit, which are encoding targets, or may receive multiple coding tree units or coding units and store the multiple coding tree units or coding units in a buffer. When the encoding target unit to be processed is already stored in the buffer, this step may be omitted.

Next, the encoding apparatus may perform encoding for designating a processing order of units included in the received encoding target unit at step S602. At this step, the encoding apparatus may determine the processing order of units included in the coding tree unit. The encoder may determine the processing order based on the size, location, or prediction mode, etc. of units included in the encoding target unit, or may determine the processing order based on Rate Distortion (RD) costs. When necessary, the processing order of units included in the encoding target unit may be signaled to the decoder through a bitstream.

Next, the encoding apparatus determines whether there is a unit to be encoded after the encoding target unit at step S603. For example, the encoding apparatus may determine whether there is a subsequent unit to be encoded based on whether the coding tree unit is the last unit in a frame (or a slice), whether the coding unit is the last unit in the coding tree unit, or whether the transform unit or the prediction unit is the last unit in the coding unit. When the encoding target unit is the last unit, encoding of a standard unit (for example, a frame, a slice, a coding tree unit, or a coding unit) including the encoding target unit may be terminated. When the encoding target unit is not the last unit, the subsequent encoding target unit may be received.

In the above-described example, the encoding apparatus may determine the processing order based on the size, location, or prediction mode, etc. of units included in the encoding target unit.

For example, the encoding apparatus may determine the processing order of units based on the size of the unit. In this case, the encoder may determine a processing order of a large size block to precede a processing order of a small size block. Reversely, the encoder may determine a processing order of a small size block to precede a processing order of a large size block.

As another example, the encoding apparatus may determine a processing order of units based on the prediction mode of the units. For example, the encoding apparatus may determine, in P or B slice, a processing order of a block in an inter-prediction mode to precede a processing order of a block in an intra-prediction mode. Alternatively, the encoding apparatus may determine the processing order of units based on intra-prediction mode directions or inter-prediction mode methods (for example, the skip mode, the merge mode, or the AMVP mode, etc) of the units.

The encoding apparatus may determine the processing order of units in the encoding target unit based on a processing order of a unit adjacent to the encoding target unit or on a processing order of a collocated unit included in a frame having different temporal order from a current frame.

Alternatively, the encoding apparatus may derive the optimum processing order by changing the processing order of units. For example, the encoder may calculate the rate distortion (RD) costs by changing the processing order of units included in the encoding target unit, and may determine the optimum processing order based on the RD costs. Generally, the combination having the lowest RD costs may be determined as the optimum processing order.

The encoding apparatus may signal information for the processing order of units included in the encoding target unit to the decoding apparatus. Here, the information for the processing order may be signaled for each unit included in the encoding target unit, and may be signaled through the upper layer than the relevant unit.

However, when the processing order of units included in the encoding target unit is derived based on characteristics of units (for example, the size, location, or prediction mode, etc. of a unit), information for the processing order of the units may not be signaled.

According to the embodiment, the encoding apparatus may determine the processing order of the coding units included in the coding tree unit while encoding the coding tree unit, or may determine the processing order of the prediction units or the transform units included in the coding unit while encoding the coding unit.

Hereinafter, according to encoding steps, a method for encoding the processing order of the coding units while encoding the coding tree unit, and a method for encoding the processing order of the prediction units or the transform units while encoding the coding unit will be described in detail.

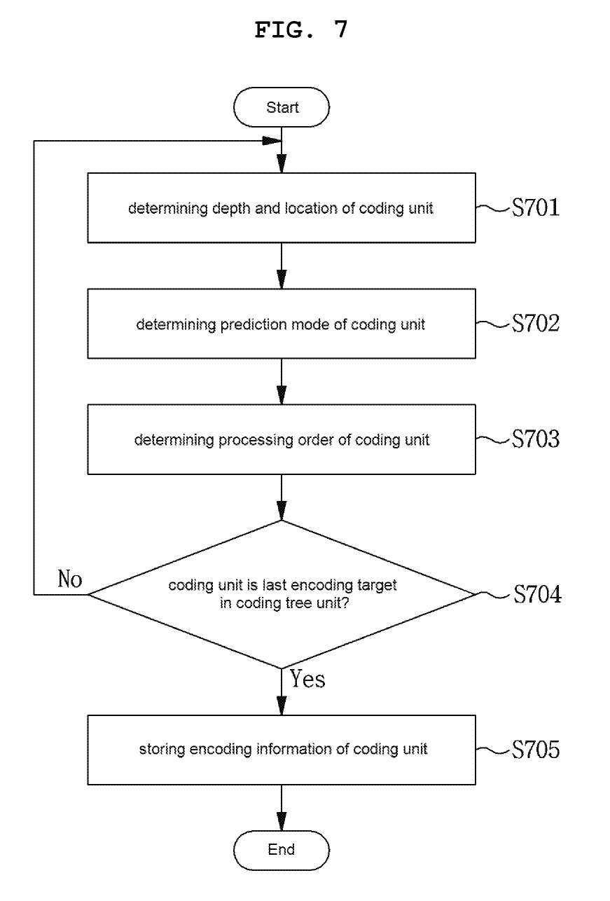

FIG. 7 is a view showing an encoding method for designating a processing order of coding units in a coding tree unit according to an embodiment of the present invention. FIG. 7 shows the embodiment for explaining the encoding step S602 of FIG. 6 in detail. A series of processes of FIG. 7 may be repeatedly performed in order to determine the final encoding mode and the processing order of the coding units in the coding tree unit.

Referring to FIG. 7, first, the encoding apparatus may determine the depth and location of the coding unit in the coding tree unit to be encoded at step S701. At this step, the encoding apparatus may determine the depth and location of the coding unit based on characteristics of the original image, encoding information of the neighboring coding unit and the prediction unit, encoding information of a different coding unit in the already-encoded frame or of the prediction unit related to the different coding unit, etc. Here, the characteristics of the original image may include complexity, motion, or edge possibility, etc. of an image.

Next, the encoding apparatus may determine at least one of intra prediction or inter prediction for the determined coding unit as a prediction mode of the coding unit at step S702.

In addition, the encoding apparatus may determine the processing order of the coding units at step S703. The encoding apparatus may determine the processing order of the coding units in order to process coding units included in the coding tree unit in series, or may determine the processing order of the coding units in order to process the coding units in parallel. Here, processing of the coding units in series may be performed by assigning a different processing order for each coding unit (that is, processing order is determined to be in ascending or descending order). In addition, processing of coding units in parallel may be performed by assigning the same processing order to the coding units.

The encoding apparatus may determine the processing order of the coding units based on the size of the coding units or the prediction mode of the coding units.

As another example, the encoding apparatus may determine the processing order of the coding units in the coding tree unit based on the processing order of the coding units in the neighboring coding tree unit, or on the processing order of the coding units in the coding tree unit included in a frame having different temporal order from a current frame.

Alternatively, the encoding apparatus may calculate RD costs by changing the processing order of coding units, and may determine the optimum processing order based on the RD costs.

Next, the encoding apparatus may determine whether the coding unit is the last coding unit in the coding tree unit at step S704. When there is no coding unit to be encoded, encoding information of the coding tree unit including the processing order of the coding units may be stored at step S705. When the coding unit is not the last coding unit in the coding tree unit, the subsequent coding unit may be encoded.

The processing order of the coding units included in the coding tree unit may be signaled for the coding unit. Alternatively, the processing order of coding units included in the coding tree unit may be signaled through the coding tree unit or the slice.

Next, an example of encoding the processing order of the prediction units in the coding unit will be described.

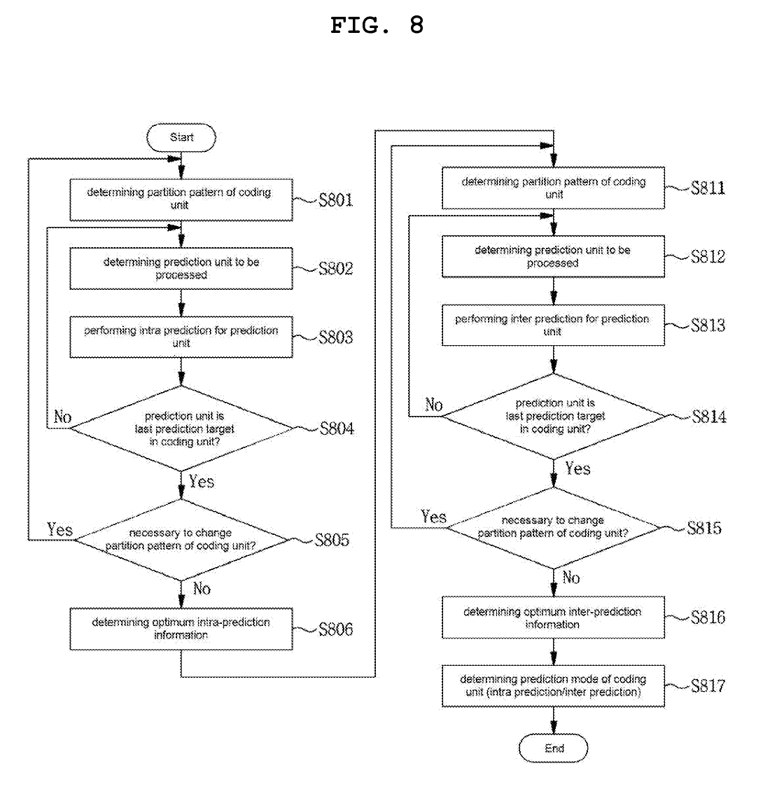

FIG. 8 explains an example of encoding the processing order of the prediction units in the coding unit. The embodiment of FIG. 8 is provided to explain the determining of the prediction mode at step S702 of FIG. 7 in detail.

FIG. 8 is a flowchart showing a method for encoding a coding unit according to an embodiment of the present invention. A series of processes of FIG. 8 may be repeatedly performed in order to determine the final prediction mode and the processing order of the prediction units in the relevant coding unit. For convenience of description, it is assumed that the prediction mode of the coding unit is intra prediction in FIG. 8.

Referring to FIG. 8, first, the encoding apparatus may determine a partition method of the coding unit for intra prediction at step S801. At this step, the encoding apparatus may determine one of partition methods supported in intra prediction as a partition method of a current coding unit.

For example, as described above through FIG. 4, the coding unit encoded in intra prediction may use a partition method of a 2N×2N mode or an N×N mode. Here, only one prediction unit is used without partitioning the coding unit in the 2N×2N mode, and the coding unit is partitioned into four prediction units in the N×N mode.

When a plurality of prediction units is included in a coding unit due to partition of the coding unit, the encoding apparatus may determine a prediction unit to be processed among the plurality of prediction units at step S802. For example, when the N×N mode is selected as the partition method of the coding unit, the encoding apparatus may determine at least one of four prediction units included in the coding unit as a processing target.

When the 2N×2N mode is selected as the partition method of the coding unit, one prediction unit exists in the coding unit. Accordingly, a prediction unit having the same size as the coding unit may be selected at this step.

Next, at step S803, the encoding apparatus may perform intra prediction for the prediction unit selected at the previous step.

Next, the encoding apparatus may determine whether the prediction unit is the last prediction unit in the coding unit at step S804. When the prediction unit is not the last prediction unit in the coding unit, in order to perform prediction on another prediction unit, the determining of the prediction unit at step S802 is performed again.

In determining a prediction unit, which is a processing target, the encoding apparatus may use at least one of a characteristic of the original image, encoding information of the neighboring coding unit or of the neighboring prediction unit, encoding information of the coding unit or the prediction unit in the already encoded frame, or the size of the prediction unit or partition pattern of the coding unit. Accordingly, the processing order of the prediction units may be determined based on the enumerated information.

Alternatively, the encoding apparatus may repeatedly perform intra prediction by changing the processing order of the prediction units in order to determine the processing order of the prediction units in the coding unit. The encoding apparatus may repeatedly perform intra prediction by changing the processing order of the prediction units, and may determine the optimum processing order of the prediction units based on the result of the performance.

When there is no more prediction unit for prediction, it is possible to determine whether intra prediction is performed based on another partition method at step S805.

When it is desired to perform intra prediction according to another partition method, the determining of the partition method of the prediction unit at step S801 may be performed again.

When determining that inter prediction is not performed any more based on another partition method, the optimum partition method for intra prediction, a prediction mode or the processing order of the prediction units in the coding unit, etc. may be determined at step S806.

Next, the encoding apparatus may determine a partition method of the coding unit for inter prediction at step S811. At this step, the encoding apparatus may determine one of partition methods supported in inter prediction as a partition method of a current coding unit.

For example, as described above through FIG. 4, the coding unit encoded in inter prediction may use a partition method such as a 2N×2N mode, a 2N×N mode, an N×2N mode, a 2N×nU mode, a 2N×nD mode, an nL×2N mode, an nR×2N mode, or an N×N mode, etc. Here, only one prediction unit is used without partitioning a coding unit in the 2N×2N mode, and a coding unit is partitioned into four prediction units in the N×N mode. Except for the 2N×2N and N×N modes, a coding unit is partitioned into two prediction units in remaining modes (namely, 2N×N, N×2N, 2N×nU, 2N×nD, nL×2N, and nR×2N modes).

Next, the encoding apparatus may determine a prediction unit in the coding unit to be processed at step S812. For example, when the partitioned method is selected except for the 2N×2N mode, at least one of a plurality of prediction units included in the coding unit may be selected. Here, the encoding apparatus may use at least one of characteristics of the original image, encoding information of neighboring coding unit or of neighboring prediction unit, or encoding information of the coding unit or the prediction unit in the already encoded frame.

When the 2N×2N mode is selected as a partition method of the prediction unit at the previous step, one prediction unit exists in the coding unit. Accordingly, a prediction unit having the same size as the coding unit may be selected at this step.

Next, at step S813, the encoding apparatus may perform inter prediction for the prediction unit that is selected at the previous step.

Next, the encoding apparatus may determine whether the relevant prediction unit is the last prediction unit in the coding unit at step S814. When the prediction unit is not the last prediction unit in the coding unit, the determining of the prediction unit at step S812 may be performed again in order to perform inter prediction for another prediction unit.

In determining a prediction unit which is a processing target, the encoding apparatus may use at least one of characteristic of the original image, encoding information of the neighboring coding unit or of the neighboring prediction unit, encoding information of the coding unit or the prediction unit in the already encoded frame, or the size of the prediction unit or partition pattern of the coding unit. Accordingly, the processing order of the prediction units may be determined based on the enumerated information.

Alternatively, the encoding apparatus may repeatedly perform intra prediction by changing the processing order of the prediction units in order to determine the processing order of the prediction units in the coding unit. The encoding apparatus may repeatedly perform intra prediction by changing the processing order of the prediction units, and may determine the optimum processing order of the prediction units based on the result of the performance.

When there is no more prediction unit for prediction, it is possible to determine whether intra prediction is performed based on another partition method at step S815. When it is desired to perform inter prediction according to another partition method, the determining of the partition method of the prediction unit at step S811 may be performed again.

When determining that inter prediction is not performed any more based on another partition method, the optimum partition method for intra prediction, motion information, or the processing order of the prediction units in the coding unit, etc. may be determined at step S816.

Next, the encoding apparatus may determine the final prediction mode for the coding unit at step S817. For example, the encoding apparatus may determine intra prediction or inter prediction as the final prediction mode of the coding unit by comparing the results of intra prediction and inter prediction.

When the final prediction mode for the coding unit is determined, the encoding apparatus may store information related to the determined prediction mode. Here, information related to the prediction mode may include information for the processing order of the prediction units in the coding unit.

In FIG. 8, intra prediction processes from S801 to S806 and inter prediction processes from S811 to S816 are not affected by performance order of each other. That is, inter prediction is performed after intra prediction in FIG. 8, however, reversely, intra prediction may be performed after inter prediction. Alternatively, inter prediction and intra prediction may be simultaneously performed.

Not shown in the drawings, the encoding apparatus may determine the processing order of transform units in the coding unit. Here, the processing order of the transform units may be determined based on partition depth, the size of the transform unit, or the pattern of the transform unit, etc.

Alternatively, the encoding apparatus may repeatedly encode a residual signal by changing the processing order of the transform units in order to determine the processing order of the transform units in the coding unit. The encoding apparatus may repeatedly encode the residual signal by changing the processing order of the transform units, and may determine the optimum processing order of the transform units based on the result of the performance.

Next, a method for decoding an image frame by the decoding apparatus will be described.

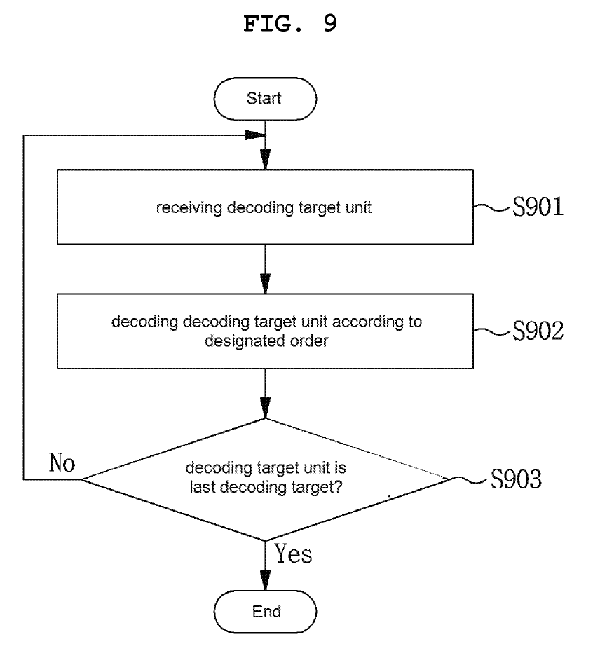

FIG. 9 is a flowchart showing a method for decoding an image frame according to an embodiment of the present invention. Specifically, FIG. 9 shows a method for decoding based on processing order of the units. Here, the processing order is a decoding order. In addition, the embodiment may relate to the processing order of coding units included in the coding tree unit, or to the processing order of prediction units or transform units included in the coding unit.

Referring to FIG. 9, first, the decoding apparatus may receive a decoding target unit at step S901. At this step, the decoding apparatus may receive one decoding target unit, or may receive multiple decoding target units at once and store the multiple decoding target units in a buffer. When the decoding target unit to be processed is already stored in the buffer, this step may be omitted. Here, the decoding target unit may be a coding tree unit, or a coding unit. etc.

Next, the decoding apparatus may perform decoding according to the designated order for the received decoding target units at step S902. For example, the decoding apparatus may perform decoding based on the processing order of coding units, transform units or prediction units included in the received decoding target unit. Information for the processing order may be signaled from the encoding apparatus, or may be derived from a neighboring unit adjacent to the decoding target unit, etc.

Next, at step S903, decoding apparatus determines whether there is a unit to be decoded after the decoding target unit that is processed at the previous step. For example, the decoding apparatus may determine whether there is a subsequent unit to be decoded based on whether the coding tree unit is the last unit in a frame (or a slice), whether the coding unit is the last unit in the coding tree unit, or whether the prediction unit or the transform unit is the last unit in the coding unit, etc. When the decoding target unit is the last unit, decoding of a standard unit (for example, a frame, a slice, a coding tree unit, or a coding unit) including the decoding target unit may be terminated. When the decoding target unit is not the last coding tree unit, the subsequent decoding target unit may be received.

In the above-described example, the decoding apparatus may determine the processing order of units based on the size, location, or prediction mode, etc. of units included in the decoding target unit.

For example, the decoding apparatus may determine the processing order of units based on the size of the unit. In this case, the decoding apparatus may determine a processing order of a large size block to precede a processing order of a small size block. Reversely, the decoder may determine a processing order of a small size block to precede a processing order of a large size block.

As another example, the decoding apparatus may determine a processing order of units based on the prediction mode of the units. For example, the decoding apparatus may determine, in P or B slice, a processing order of a block in an inter-prediction mode to precede a processing order of a block in an intra-prediction mode. Alternatively, the decoding apparatus may determine the processing order of units based on intra-prediction mode or inter-prediction mode methods (for example, the skip mode, the merge mode, or the AMVP mode, etc) of the units.

The decoding apparatus may determine the processing order of units in the decoding target unit based on a processing order of a unit adjacent to the decoding target unit or on a processing order of a collocated unit of the decoding target unit included in a frame having different temporal order from a current frame.

Alternatively, the decoding apparatus may determine the processing order of units in the decoding target unit based on information that is signaled from the encoding apparatus. Here, the information for the processing order may be signaled for each unit included in the decoding target unit, and may be signaled through the upper layer than the relevant unit.

Information for the processing order may indicate raster scanning, zigzag scanning, Z-scanning, up-right scanning, horizontal direction scanning, or vertical direction scanning, etc. When information for the processing order indicates one of the enumerated scanning types, a processing order of units in the decoding target unit may be determined based on a direction determined by the scanning type. Alternatively, a processing order of units may be determined based on a direction opposite to a direction determined by the scanning type. Whether the processing order of units is determined based on a direction of the scanning type or a direction opposite to a direction of the scanning type may be transmitted from the encoding apparatus to the decoding apparatus through a bitstream.

The processing order of units is not limited to the above-described scan type. The decoder may determine the processing order of units based on information that is signaled for each unit. Here, the same ranking may exist in the decoding order of units.

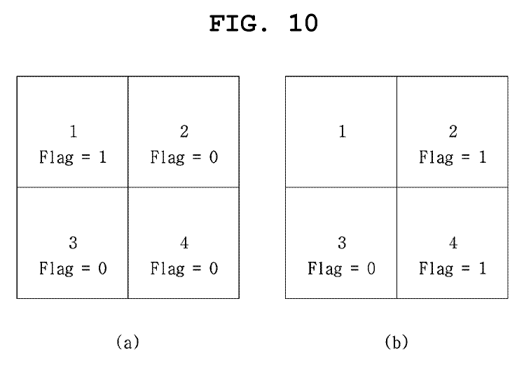

FIG. 10 is a view showing an example of determining a decoding order for a decoding target unit. For convenience of description, four blocks shown in FIG. 10 are respectively referred to as first to fourth blocks.

The decoding order of units may be determined depending on a flag value. Here, when a flag value is 1 (or 0), a decoding order of the relevant unit precedes a decoding order of a unit where a flag value is 0 (or 1). In the example shown in FIG. 10(a), the flag value of the first block is 1, and the flag values of the remaining blocks are 0. Accordingly, the first block may be decoded first among the first to fourth blocks.

After, flag information for a residual block where a decoding order is not determined may be decoded. In the example shown in FIG. 10(b), the flag values of the second and fourth blocks are 1, and the flag value of the third block is 0. Accordingly, the second and fourth blocks may be decoded after the third block.

When there are multiple blocks where the decoding order is not determined, flags for the multiple blocks may be parsed. However, like the example shown in FIG. 10(b), when there is one block where a decoding order is not determined (that is, the block where the decoding order is not determined yet is the third block), the decoding order of the block may be determined as the last without a flag.

In the example shown in FIG. 10(b), the first flag values are 0 and the second flag values are 1 in the second and fourth blocks. Like this, when there are multiple blocks where flag values are 1 at the specific time, the decoding order of the multiple blocks may be the same, or may be determined based on a predetermined direction.

For example, in FIG. 10(b), the decoding order of the second and fourth blocks may be the same ranking. In this case, the decoding order of four blocks may be determined as the order of the first, (second and fourth), third blocks.

As another example, in FIG. 10(b), the decoding order of the second and fourth blocks may be determined based on raster scanning, zigzag scanning, Z-scanning, horizontal direction scanning, vertical direction scanning, or up-right scanning. For example, when the second and fourth blocks use raster scanning, zigzag scanning, Z-scanning, horizontal direction scanning, vertical direction scanning, or up-right scanning, the decoding order of the block where the scanning order is early may precede that of the block where the scanning order is late.

Information for the processing order may indicate processing order of units. For example, in the example shown in FIG. 10, when the decoding order is determined as the order of the first, (second and fourth), and third blocks, order ‘0’ may be signaled for the first block, order ‘1’ may be signaled for the second and fourth block, order ‘2’ may be signaled for the third block.

Hereinafter, according to the decoding step, a method for decoding the coding tree unit based on the processing order of the coding units and a method for decoding the coding unit based on the processing order of the prediction units or the transform units will be described in detail.

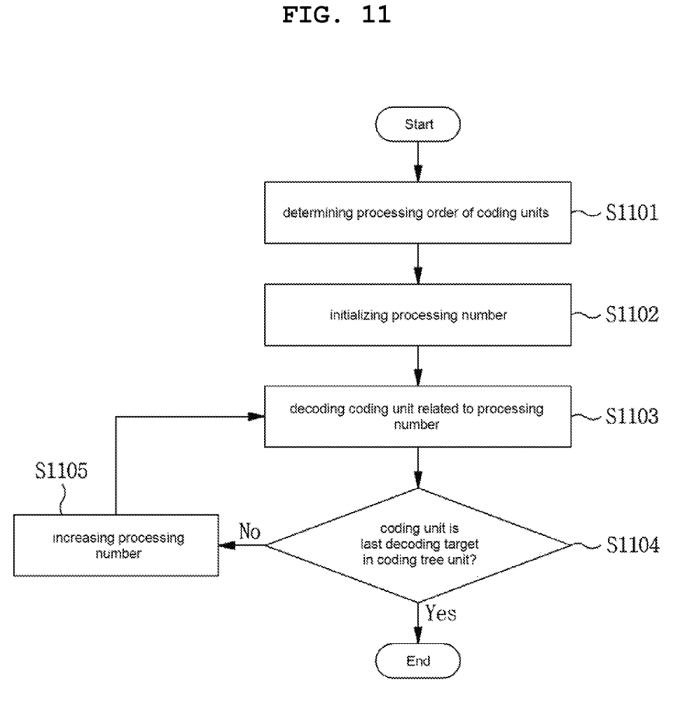

FIG. 11 is a flowchart showing a method for decoding a coding tree unit according to an embodiment of the present invention. FIG. 11 shows the embodiment for explaining the decoding step S902 of FIG. 9 in detail.

Referring to FIG. 11, first, the decoding apparatus may determine a processing order of coding units in a coding tree unit at step S1101. As described above, the processing order of the coding units may be determined based on information signaled from the decoding apparatus, or may be determined based on the size or prediction mode, etc. of a block.

When the processing order is determined, the decoding apparatus may initialize the processing number at step S1102.

Next, the decoding apparatus may decode at least one coding unit having the processing order related to the current processing number at step S1103. For example, in the example shown in FIG. 10(b), when the processing order is determined as the order of the first, (second and fourth), and third blocks, and the processing order of the first block is ‘0’, the processing order of the second and fourth blocks is ‘1’, the processing order of the third block is ‘3’, and the current processing order is ‘0’, the first block may be decoded. In contrast, when the current processing order is ‘1’, the second and fourth blocks may be decoded.

Here, when there are coding units having the same processing order in the same coding tree unit, the decoding apparatus may decode the coding units having the same processing order in series, or may simultaneously decode the coding units.

The decoding apparatus may determine whether the coding unit that is processed just before is the last coding unit in the coding tree unit at step S1104. When the coding unit is the last coding unit in the coding tree unit, decoding may be terminated. Otherwise, the decoding apparatus may increase the current processing number for the coding unit at step S1105. The decoding apparatus may decode the coding units in the coding tree unit by repeatedly performing the processes of decoding the coding units based on the processing number.

Hereinafter, a method for decoding prediction units in the coding unit will be described.

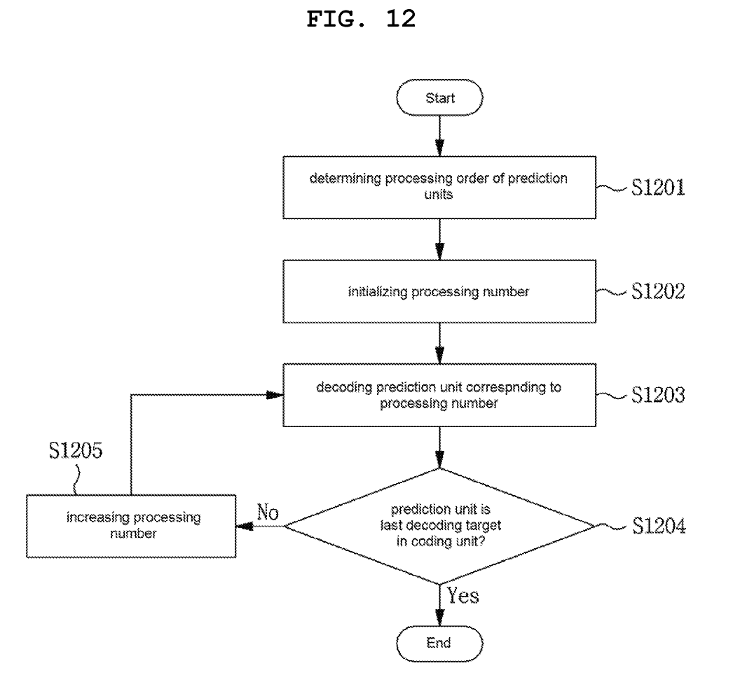

FIG. 12 is a flowchart showing a method for decoding a coding unit according to an embodiment of the present invention. FIG. 12 shows a method for decoding a video based on processing order designation of prediction units. FIG. 12 shows the embodiment for explaining the decoding step S1103 of FIG. 11 in detail.

Referring to FIG. 12, first, the decoding apparatus may determine a processing order of prediction units in a coding unit at step S1201. As described above, the processing order of the prediction units may be determined based on information signaled from the decoding apparatus, or may be determined based on the size or form, etc. of a block.

When the processing order is determined, the decoding apparatus may initialize the processing number at step S1202.

Next, the decoding apparatus may decode at least one prediction unit having a processing order corresponding to the current processing number at step S1203. Specifically, the decoding apparatus may perform inter prediction or intra prediction on the prediction unit having the processing order corresponding to the current processing number.

When there are prediction units having the same processing order in the coding unit, the prediction units having the same processing order may be decoded in series, or may be simultaneously decoded.

The decoding apparatus may determine whether the prediction unit that is processed just before is the last prediction unit in the coding unit at step S1204. When the prediction unit is the last prediction unit in the coding unit, decoding may be terminated. Otherwise, the decoding apparatus may increase the current processing number for the prediction unit at step S1105. The decoding apparatus may decode prediction units in the coding unit by repeatedly performing the processes of decoding the prediction units based on the processing number.

In FIG. 12, the example of the prediction unit included in the coding unit is described, but the transform unit included in the coding unit may be decoded based on the processing order.

When using raster scanning, zigzag scanning, Z-scanning, horizontal direction scanning, vertical direction scanning, or up-right scanning, the processing order of a neighboring unit adjacent to the left or the top of a current unit precedes that of the current unit. That is, the current unit may be encoded/decoded based on information of the neighboring unit adjacent to the left or the top of the current unit.

However, when the processing order of units is determined without using the above-mentioned scanning method, the processing order of a neighboring unit adjacent to the right or the bottom of the current unit may be set to precede that of the current unit. Accordingly, a method for encoding/decoding the current unit may be considered by using information of both the neighboring units adjacent to the left or the top of the current unit and the neighboring units adjacent to the right or the bottom of the current unit.

Hereinafter, assuming that the current block is the prediction unit, a method for encoding/decoding the current block by using neighboring blocks of the current block will be described in detail.

FIG. 13 is a view showing locations of both a current block and reference samples of the current block according to an embodiment of the present invention. Here, the reference sample is a sample for decoding the current block by using an intra-prediction method.

For convenience of description, like the example shown in FIG. 13, the reference sample of the current block may be divided into eight regions respectively including at least one sample. For example, depending on the locations to the current block 1310, the reference sample may include: the top reference sample 1320 (hereinafter, referred to as ‘T’); the right top reference sample 1321 (hereinafter, referred to as ‘RT’); the right reference sample 1322 (hereinafter, referred to as ‘R’); the right bottom reference sample 1323 (hereinafter, referred to as); the bottom reference sample 1324 (hereinafter, referred to as ‘BT’); the left bottom reference sample 1325 (hereinafter, referred to as ‘LB’); the left reference sample 1326 (hereinafter, referred to as ‘L’); or the left top reference sample 1327 (hereinafter, referred to as ‘LT’).

Unless there is special explanation, it is assumed that samples (RT, RB, LT, LB), etc. adjacent to the corners of the current block are respectively included in the top reference sample, the right reference sample, the left reference sample, or the bottom reference sample.

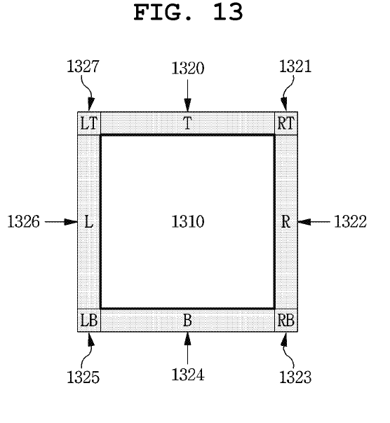

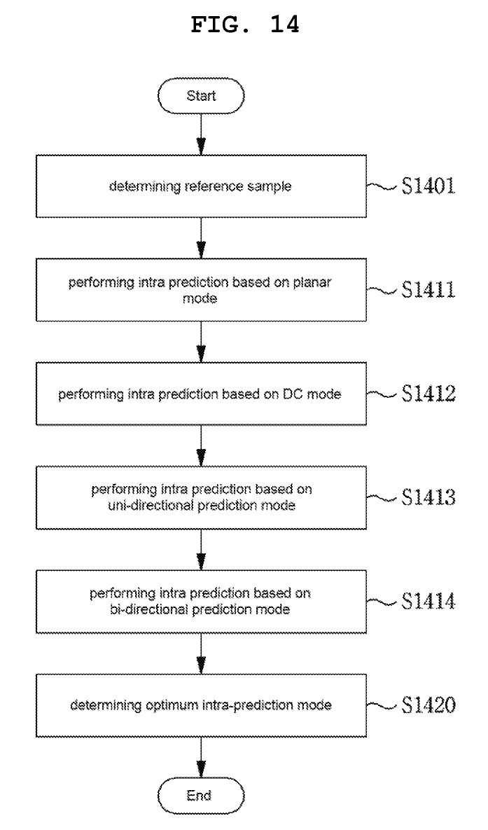

FIG. 14 is a flowchart showing a method for encoding a current block according to an embodiment of the present invention. Specifically, FIG. 14 shows a method where reference samples are determined based on usable blocks adjacent to the current block, intra prediction for each prediction mode is performed by using the reference samples, and the optimum intra-prediction mode is determined through the result of intra prediction.

Referring to FIG. 14, the encoding apparatus may determine the reference samples based on the usable blocks among the neighboring blocks surrounding the current block at step S1401. At this step, whether each of the reference samples is usable may be determined.

For example, when a neighboring block is decoded before the current block, the sample included in the neighboring may be determined as a usable sample. The sample included in the neighboring block may be used as the reference sample for intra prediction of the current block.

In the meantime, when a neighboring block is not encoded yet, the sample included in the neighboring block may be determined as an unusable sample. The unusable sample may be replaced with the middle value, etc. of a usable sample adjacent to the current block or of two or more usable samples.

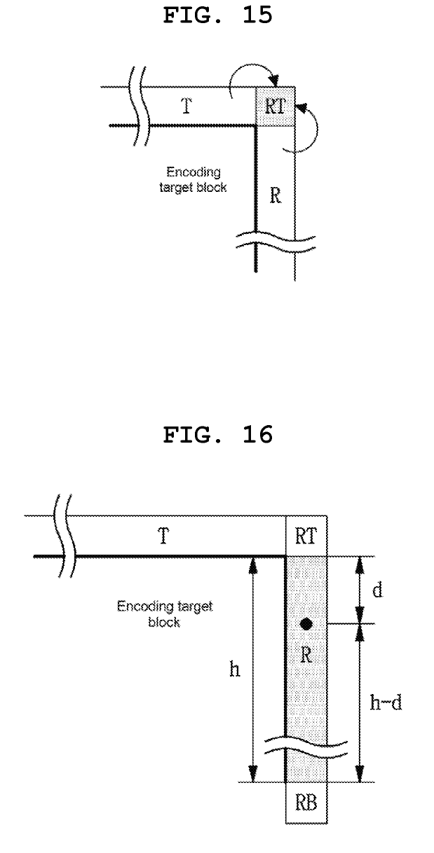

FIGS. 15 and 16 are views for explaining an example of replacing the unusable sample.

When the sample adjacent to the current block is determined as an unusable sample, the sample may be replaced with a value interpolating two or more samples of the unusable sample.

For example, in the example shown in FIG. 15, when the right top sample RT of the current block is determined as the unusable sample, the right top sample may be replaced with the average value of the rightmost sample of the top reference sample T and the topmost sample of the right reference sample R.

Not shown in the drawings, when the samples adjacent to the corners of the current block, such as the left top sample LT, the right bottom sample RB, the left bottom sample LB, etc. of the current block, are unusable samples, each unusable sample may be replaced with an average value of two samples adjacent to the unusable sample.

As another example, the replacement value of the unusable sample may be calculated by using both the sample located at the top or the left of the unusable sample and the sample located at the bottom or the right of the unusable sample. Here, the sample located at the top or the left of the unusable sample may be the left top sample LT or the right top sample RT adjacent to the corner of the current block, or may be the usable sample that is closest to the unusable sample between the samples located at the top or the left of the unusable sample. In addition, the sample located at the bottom or the right of the unusable sample may be the left bottom sample LB or the right bottom sample RB adjacent to the corner of the current block, or may be the usable sample that is closest to the unusable sample between the samples located at the bottom or the right of the unusable sample.

For example, when the sample R adjacent to the right of the current block is the unusable sample, as shown in the example of FIG. 16, a replacement value of the unusable sample may be obtained by using the samples RT and RB adjacent to the right top corner and the right bottom corner of the current block.

Here, the replacement value of the unusable sample may be determined by considering the distance between the unusable sample and the right top sample and the distance between the unusable sample and the right bottom sample. For example, the value of the unusable sample may follow formula 1.

$${S}_{R} = ( \frac{h - d}{h} {S}_{RT} + \frac{d}{h} {S}_{RB} + 1 ) K 1 \qquad formula 1$$

In formula 1, a replacement value replacing the unusable sample is designated as S_{R}, a value of the right top sample is designated as S_{RT}, a value of the right bottom sample is designated as S_{RB}. The distance between the unusable sample and the right top sample is designated as d, the distance between the right top sample and the right bottom sample is designated as h. Accordingly, the distance between the unusable sample and the right bottom sample may be designated as h-d.

As shown in FIG. 16, the replacement value of the unusable sample may be calculated based on the samples located at the opposite sides of the unusable sample.

When it is impossible to use one of the samples located at the opposite sides of the unusable sample, the sample value of the usable sample adjacent to the unusable sample may be applied to the unusable sample. For example, when the sample adjacent to the right of the current block is the unusable sample, the replacement value of the unusable sample may be calculated by using both the sample located at the top of the unusable sample and the sample located at the bottom of the unusable sample. Here, when it is impossible to use one of the sample located at the top of the unusable sample and the sample located at the bottom of the unusable sample, the replacement value of the unusable sample may be set as a value of the usable sample between the sample located at the top of the unusable sample and the sample located at the bottom of the unusable sample.

In the meantime, when all neighboring blocks surrounding the encoding target block are unusable, the reference sample may be interpolated with the middle value of samples.

When all reference samples are prepared, the encoding apparatus may update values of the reference samples by filtering the reference samples. Here, the filtering of the reference sample is not necessary, and may be omitted in cases.

Next, the encoding apparatus may perform intra prediction for each intra-prediction mode at steps S1411 to S1414. The intra-prediction mode is classified into a planar mode, a DC mode, a uni-directional mode, and a bi-directional mode. The performance order of intra prediction for each intra-prediction mode shown in FIG. 14 is not limited thereto. The performance order of intra prediction may be set to be different from the shown example. Whatever the performance order is, the order does not affect the final result.

The planar mode of the intra-prediction modes means a method of generating a prediction sample by considering the distance from the location of the prediction sample to be generated to the location of the neighboring reference sample. Intra prediction based on the planar mode will be described in detail with reference to the drawings.

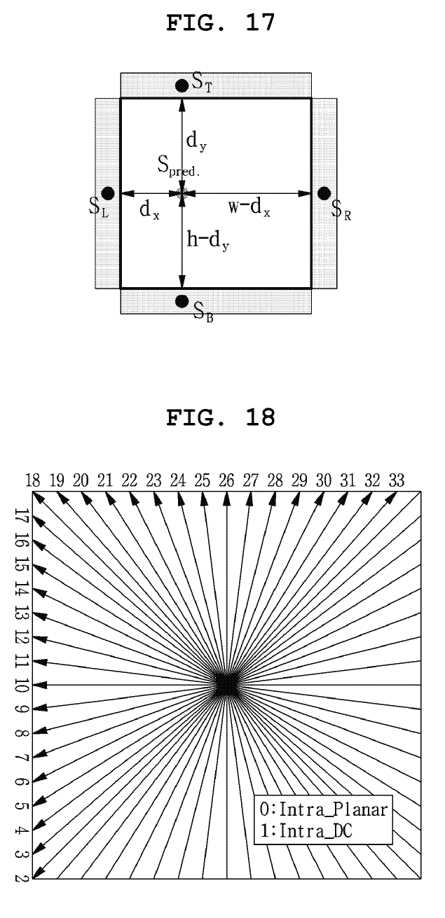

FIG. 17 is a view showing an example of performing intra prediction based on a planar mode. Referring to the sample shown in FIG. 17, a prediction sample value generated based on the planar mode may be calculated by using reference samples adjacent to the left and the right of the current block, and reference samples located at the top and the bottom of the current block. Here, the left reference sample and the right reference sample mean samples having the same Y-coordinate as the prediction sample, and the top reference sample and the bottom reference sample mean samples having the same X-coordinate as the prediction sample. The prediction sample value may be calculated as shown in the following formula 2.

$${S}_{pred} = ( \frac{w - {d}_{x}}{w} {S}_{L} + \frac{{d}_{x}}{w} {S}_{{R}^{+}} \frac{h - {d}_{y}}{h} {S}_{T} + \frac{{d}_{y}}{h} {S}_{B} + 2 ) K 2 \qquad formula 2$$

In formula 2, the prediction sample value is designated as S_{pred}, values of reference samples are designated as S_{L}, S_{R}, S_{T}, and S_{B}. The distance from the prediction sample to the left reference sample is designated as dₓ, the distance from the prediction sample to the top reference sample is designated as d_{y}. The width of the current block is designated as w, the height of the current block is designated as h. Accordingly, the distance from the prediction sample to the right reference sample is designated as w-dₓ, the distance from the prediction sample to the bottom reference sample is designated as h-d_{y}.

The DC mode means a method of predicting a current block by using an average value of neighboring reference samples.

The uni-directional prediction means performing intra prediction by using only one of reference sample groups facing each other, the bi-directional prediction means performing intra prediction by using all reference sample groups facing each other. Here, the top reference sample and the bottom reference sample may be the reference sample group facing each other, and the right reference sample and the left reference sample may be the reference sample group facing each other.

FIG. 18 is a view showing an intra-prediction direction based on a uni-directional prediction mode. FIG. 18 shows an intra-prediction direction using the left reference sample and the top reference sample.

In the example shown in FIG. 18, the numbers 2 to 33 indicate uni-directional prediction modes having different prediction directions. The prediction sample value in the current block may be generated by using a reference sample which is placed in the prediction direction on the basis of the location of the prediction sample. When using the directions shown in FIG. 18, the left reference sample or the top reference sample may be selected.

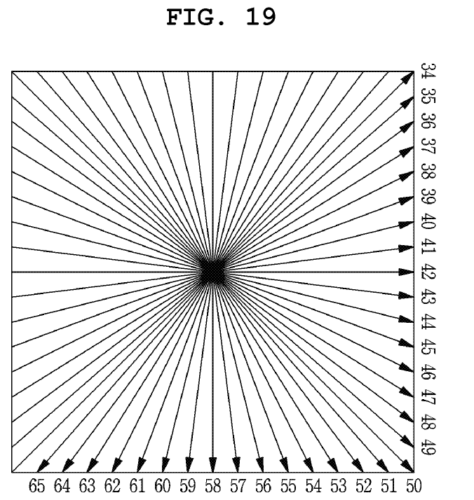

FIG. 19 is a view showing an intra-prediction direction based on a uni-directional prediction mode. FIG. 19 shows an intra-prediction direction using the right reference sample and the bottom reference sample.

In the example shown in FIG. 19, the numbers 34 to 65 indicate uni-directional prediction modes having different prediction directions. When using the directions shown in FIG. 19, the right reference sample or the bottom reference sample may be selected.

In the examples shown in FIGS. 18 and 19, when a point meeting the location of the prediction sample in the prediction direction is positioned between two reference samples, the two reference samples may be interpolated based on the distances from the point to the two reference samples and the interpolated value may be determined as the prediction sample value.

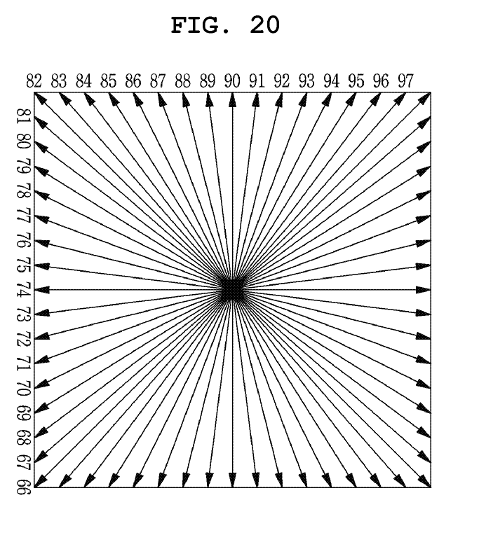

FIG. 20 is a view showing an intra-prediction direction based on a bi-directional prediction mode. FIG. 20 shows the intra-prediction direction using the reference samples that exist in the facing regions.

In FIG. 20, the numbers 66 to 97 indicate bi-directional prediction modes having different directions. The bi-directional prediction mode may be the combination of two uni-directional prediction modes. For example, the number 82 of FIG. 20 may include the directions of number 18 of FIG. 17 and of number 50 of FIG. 18.

The prediction sample for each prediction direction may be calculated by using reference samples that are respectively located in two directions indicated by the bi-directional prediction mode on the basis of the prediction sample. For example, the prediction sample may be generated by interpolating a sample located in one direction and a sample located in a direction opposite to the one direction.

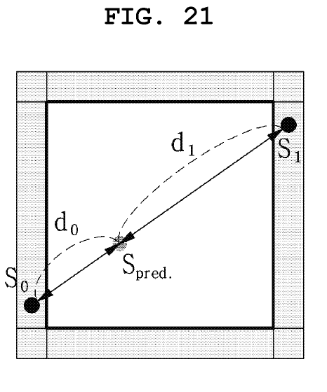

FIG. 21 is a view showing an example of generating a prediction sample in a bi-directional prediction mode.

In the bi-directional prediction mode, the prediction sample may be calculated by using two or more reference samples located at the opposite regions. For example, as shown in FIG. 21, the prediction sample may be generated by interpolating the left reference sample and the right reference sample. Here, the prediction sample value may be calculated based on the following formula 3.

$${S}_{pred} = ( \frac{{d}_{1}}{{d}_{0} + {d}_{1}} {S}_{0} + \frac{{d}_{0}}{{d}_{0} + {d}_{1}} {S}_{1} + ) K 1 \qquad formula 3$$

In formula 3, the prediction sample value is designated as S_{pred}, the value of the left reference sample is designated as S₀, the value of the right reference sample is designated as S₁. In addition, the distance between the prediction sample and the left reference sample is designated as d₀, and the distance between the prediction sample and the right reference sample is designated as d₁.

The encoding apparatus determines the intra-prediction mode having optimum prediction efficiency for the prediction result of each step performing intra prediction, and stores prediction costs caused by the intra-prediction mode. In order to calculate the prediction costs, the bit number for encoding the residual signal and the prediction mode, or the amount of the residual signal, etc. may be used.

Next, the encoding apparatus determines the optimum intra-prediction mode at step S1420. The encoding apparatus may determine the optimum intra-prediction mode for the current block based on the prediction costs stored as the result of previous steps S1411 to S1414, and may store the prediction costs caused by the optimum intra-prediction mode.

FIG. 14 shows a method for performing intra prediction in the encoding apparatus. The intra prediction method shown in FIG. 14 may be applied to the decoding apparatus.

When the decoding apparatus decodes the current block by performing intra prediction, the prediction mode of the current block may be derived from the neighboring unit adjacent to the current block. Here, the neighboring block adjacent to the current block may include blocks located at the left, the top, the right, and the bottom of the current block.

Here, information indicating whether the prediction mode of the current block is the same as the prediction mode of the neighboring block (for example, a 1 bit flag) may be signaled by the encoding apparatus.

In addition, it is possible to signal information indicating whether the prediction mode of the current block has a direction opposite to a direction of the prediction mode of the neighboring block (for example, a 1 bit flag), or information indicating whether the prediction mode of the current block is the bi-directional prediction mode including the uni-directional prediction mode (for example, a 1 bit flag) when the prediction mode of the neighboring block is the uni-directional prediction mode, etc.

The components described in the exemplary embodiments of the present invention may be achieved by at least one of a digital signal processor (DSP), a processor, a controller, an application specific integrated circuit (asic), a programmable logic element such as a field programmable gate array (FPGA), other electronic devices, and combinations thereof. At least one of the functions or the processes described in the exemplary embodiments of the present invention may be achieved by software, and the software may be recorded on a recording medium. Examples of the computer-readable storage medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), and flash memory, which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention. Components, functions, processes, etc. according to the embodiments of the present invention may be implemented in the form of a combination of hardware and software.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in encoding/decoding an image.

1. A method for encoding a video signal, the method comprising:
partitioning an encoding target block into a plurality of sub-blocks;
determining a processing order of the sub-blocks included in the encoding target block; and
entropy decoding information of the processing order of the sub-blocks.

2. The method of claim 1, wherein the processing order is selected among a plurality of processing order combinations that are generated by using the sub-blocks, with reference to results of decoding the encoding target block by using each of the processing order combinations.

3. The method of claim 1, wherein the processing order is determined based on at least one of sizes of the sub-blocks, locations of the sub-blocks, or prediction modes for the sub-blocks.

4. The method of claim 3, wherein the processing order of a sub-block is determined to precede when the size of the sub-block is larger than other sub-blocks.

5. The method of claim 3, wherein the processing order of a sub-block encoded in inter prediction is determined to precede the processing order of a sub-block encoded in intra prediction.

6. The method of claim 1, wherein the encoding target block is a coding tree unit, each of the sub-blocks is a coding unit included in the coding tree unit, and the coding tree unit is partitioned in a quad-tree or binary-tree pattern.

7. The method of claim 1, wherein the encoding target block is a coding unit, each of the sub-blocks is a prediction unit included in the coding unit, and partition pattern of the coding unit is determined based on a prediction mode.

8. The method of claim 7, wherein the processing order is determined based on an intra-prediction mode of the prediction unit or an inter-prediction mode of the prediction unit.

9. A method for decoding a video signal, the method comprising:
partitioning a decoding target block into a plurality of sub-blocks;
determining a processing order of the sub-blocks included in the decoding target block; and
decoding the sub-blocks in series based on the processing order.

10. The method of claim 9, wherein the decoding of the sub-blocks in series comprises:
determining a sub-block having a processing order related to a current order among the sub-blocks;
decoding the sub-block; and
increasing the current order when the sub-block is not a last sub-block in the decoding target block.

11. The method of claim 10, wherein when there is a plurality of sub-blocks having a processing order related to the current order, the sub-blocks having a same ranking in the processing order are decoded in parallel.

12. The method of claim 10, wherein when there is a plurality of sub-blocks to be decoded in the current order, the processing order of the sub-blocks having a same ranking in the processing order is determined based on a raster scanning order or a zigzag scanning order.

13. The method of claim 9, wherein the processing order is determined based on information of the processing order that is entropy decoded from a bitstream, and the information of the processing order includes a flag indicating whether a sub-block is decoded in the current order.

14. The method of claim 9, wherein the processing order is determined based on at least one of sizes of the sub-blocks, locations of the sub-blocks, or prediction modes for the sub-blocks.

15. The method of claim 14, wherein the processing order of a sub-block is determined to precede when the size of the sub-block is larger than other sub-blocks.

16. The method of claim 14, wherein the processing order of a sub-block encoded in inter prediction is determined to precede the processing order of a sub-block encoded in intra prediction.

17. An apparatus for encoding a video signal, the apparatus comprising:
a prediction unit partitioning an encoding target block into a plurality of sub-blocks and determining a processing order of the sub-blocks included in the encoding target block; and
an entropy decoding unit entropy decoding information of the processing order of the sub-blocks.

18. An apparatus for decoding a video signal, the apparatus comprising:
a prediction unit partitioning a decoding target block into a plurality of sub-blocks, determining a processing order of the sub-blocks included in the decoding target block, and decoding the sub-blocks in series based on the processing order.
